(19) United States
(12) Patent Application Publication
(10) Pub. No.: US 2021/0196992 A1
(43) Pub. Date: Jul. 1, 2021

(54) Combination air filter and protective mask

(71) Applicant: Shang-Fang Yu, Taichung (TW)

(72) Inventor: Shang-Fang Yu, Taichung (TW)

(21) Appl. No.: 17/092,365

(22) Filed: Nov. 9, 2020

(51) Int. Cl. A62B 7/12; A62B 7/10; A62B 23/02; A62B 18/00; A62B 18/02

(52) U.S. Cl. CPC A62B 7/12; A62B 7/10; A62B 18/02; A62B 18/006; A62B 23/02

(57) ABSTRACT

A combination air filter and protective mask includes an air pump; a first line having a first end connected to the air pump; an air filter connected to a second end of the first line; a second line having a first end connected to the air filter; a connecter connected to a second end of the second line; a third line having a first end connected to the connector; and a full face mask connected to a second end of the third line.

### BACKGROUND OF THE INVENTION

### 1. Field of the Invention

The invention relates to masks and more particularly to a combination air filter and protective mask.

### 2. Description of Related Art

Protective masks are pieces of kit worn on the head and face to afford protection to the wearer. Its functions include providing a supply of air or filtering the outside air, protecting the face against flying objects or dangerous environments while allowing vision, and warding off plaque. For example, people are encouraged to wear a mask during Covid-19 pandemic.

However, conventional protective masks are neither effective nor sufficient when a wearer (e.g., patient) needs a great volume of fresh air.

Thus, the need for improvement still exists.

### SUMMARY OF THE INVENTION

It is therefore one object of the invention to provide a combination air filter and protective mask comprising an air pump; a first line having a first end connected to the air pump; an air filter connected to a second end of the first line; a second line having a first end connected to the air filter; a connecter connected to a second end of the second line; a third line having a first end connected to the connector; and a protective mask connected to a second end of the third line.

The above and other objects, features and advantages of the invention will become apparent from the following detailed description taken with the accompanying drawings.

### BRIEF DESCRIPTION OF THE DRAWINGS

FIG. 1 is a schematic view of a combination air filter and protective mask according to a first preferred embodiment of the invention;

FIG. 2 schematically depicts the full face mask; and

FIG. 3 is a schematic view of a combination air filter and protective mask according to a second preferred embodiment of the invention.

### DETAILED DESCRIPTION OF THE INVENTION

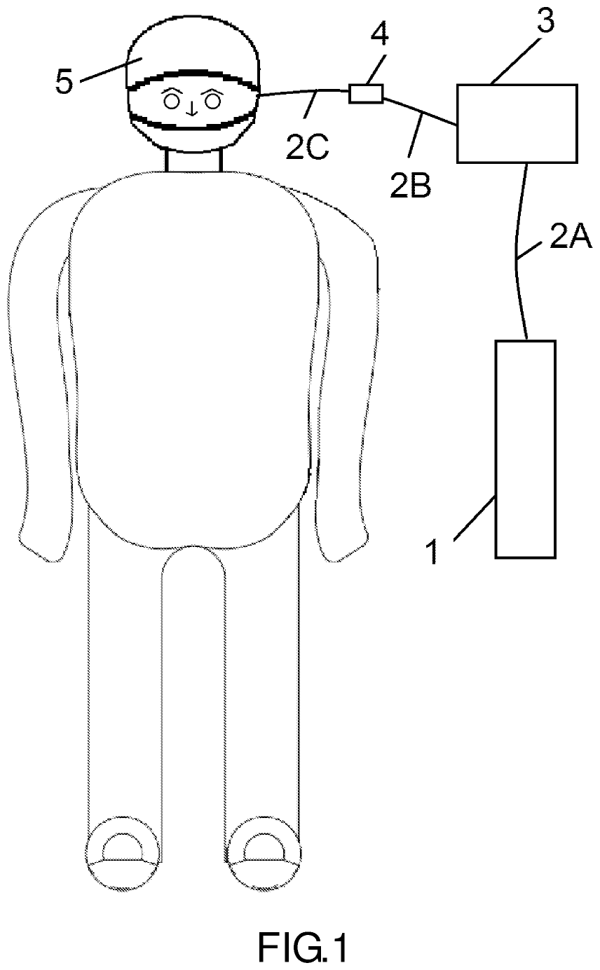

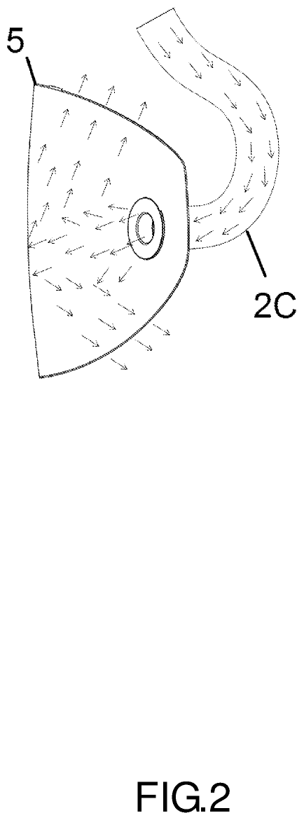

Referring to FIGS. 1 to 2, a combination air filter and protective mask in accordance with a first preferred embodiment of the invention comprises an air pump 1, a first line 2A having a first end connected to the air pump 1, an air filter 3 connected to a second end of the first line 2A, a second line 2B having a first end connected to the air filter 3, a connecter 4 connected to a second end of the second line 2B, a third line 2C having a first end connected to the connector 4, and a full face mask 5 connected to a second end of the third line 2C.

The air pump 2 can be activated if a person wearing the full face mask 5 needs a great volume of fresh air. Then the air flows from the air pump 2 to a space defined between the full face mask 5 and the face of the person through the first line 2A, the air filter 3 which removes solid particulates such as dust, pollen, mold, and bacteria from the air to generate fresh air, the second line 2B, the connector 4, and the third line 2C.

As shown in FIG. 2 specifically, inside of the full face mask 5 is filled with fresh air (indicated by arrows).

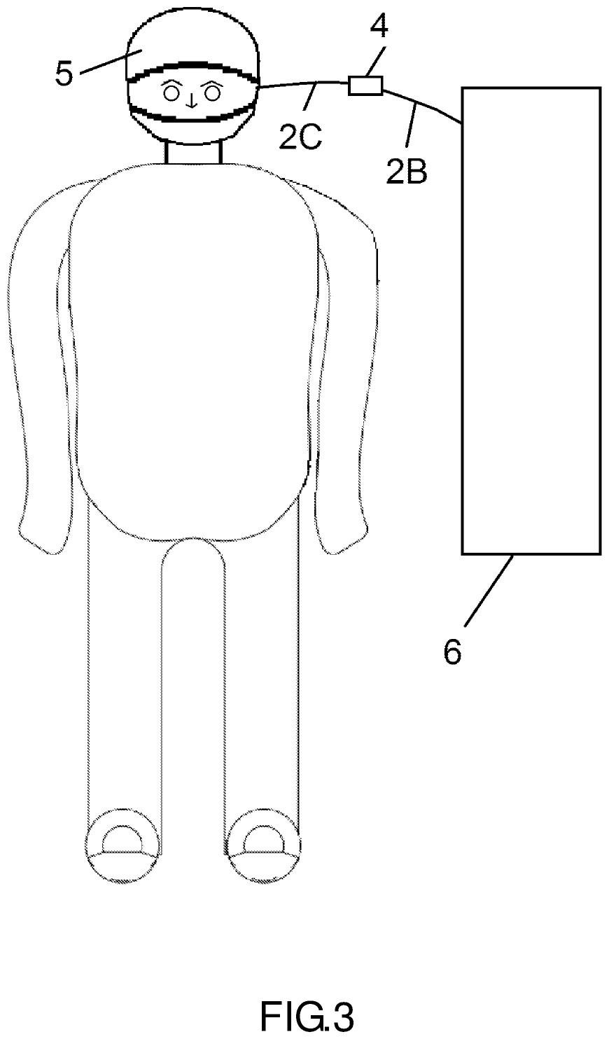

Referring to FIG. 3, a combination air filter and protective mask in accordance with a second preferred embodiment of the invention is shown. The characteristics of the second preferred embodiment are substantially the same as that of the first preferred embodiment except the following: an oxygen tank 6 as a replacement of both the air pump 1 and the air filter 3, a second line 2B having a first end connected to the oxygen tank 6, a connecter 4 connected to a second end of the second line 2B, a third line 2C having a first end connected to the connector 4, and a full face mask 5 connected to a second end of the third line 2C. The oxygen tank 6 can be opened if a person wearing the full face mask 5 needs a great volume of fresh air. Then the fresh air flows from the oxygen tank 6 to a space defined between the full face mask 5 and the face of the person through the second line 2B, the connector 4, and the third line 2C.

While the invention has been described in terms of preferred embodiments, those skilled in the art will recognize that the invention can be practiced with modifications within the spirit and scope of the appended claims.

What is claimed is:

1. A combination air filter and protective mask comprising:
an air pump;
a first line having a first end connected to the air pump;
an air filter connected to a second end of the first line;
a second line having a first end connected to the air filter;
a connecter connected to a second end of the second line;
a third line having a first end connected to the connector; and
a protective mask connected to a second end of the third line.

2. The combination air filter and protective mask of claim 1, wherein the protective mask is a full face mask.
